(19) United States
(12) Patent Application Publication
(10) Pub. No.: US 2025/0065572 A1
(43) Pub. Date: Feb. 27, 2025

(54) AN IMPLANT FOR ELECTRIC RESISTANCE WELDING OF THERMOPLASTIC COMPOSITES AND A METHOD OF WELDING BY MEANS OF THE IMPLANT

(71) Applicant: POLSKIE ZAKLADY LOTNICZE SPOLKA Z OGRANICZONA ODPOWIEDZIALNOSCIA, Mielec (PL)

(72) Inventors: Jaroslaw SIENICKI, Mielec (PL); Aleksander BANAS, Rzeszow (PL); Marcin GLODZIK, Rzeszow (PL); Konrad FARBANIEC, Jasliska (PL)

(73) Assignee: POLSKIE ZAKLADY LOTNICZE SPOLKA Z OGRANICZONA ODPOWIEDZIALNOSCIA, Mielec (PL)

(21) Appl. No.: 18/720,979

(22) PCT Filed: Dec. 16, 2022
(86) PCT No.: PCT/PL2022/050095

§ 371 Date: Jun. 17, 2024

(30) Foreign Application Priority Data
Dec. 17, 2021 (PL) P.439887

(51) Int. Cl. B29C 65/34; B29C 65/00

(52) U.S. Cl. CPC B29C 65/3456; B29C 66/721

(57) ABSTRACT

An implant for electric resistance welding of elements made of composites, with a frame of thermoplastic materials, reinforced with conductive fibres, in a flat multilayered structure with an upper and lower surface, and includes an electrically resistant layer of a flat sheet with openings, made of a conductive material, additional layers made of the frame material, one of which covers the electrically resistant layer from the top, and the other one from the bottom. The implant includes porous insulating layers made of an electrically nonconductive material, one covers the implant from the top, contacting the upper layer of the frame material, and the other covers the implant from the bottom, contacting the lower layer of the frame material. The layers are merged with each other in a flat, multilayered inset placed between the welded elements, and the electrically resistant layer has electrical connections for connecting a source of electrical current.

### TECHNICAL FIELD

The invention relates to a tool for electric resistance welding of thermoplastic composites reinforced with conductive fibres, in particular carbon fibres, on a PEEK, PAEK, PPS frame. This tool has the form of an implant for resistance welding of thermoplastic composites reinforced with conductive fibres, in particular carbon fibres. The invention also relates to a method for electric resistance welding of thermoplastic composites reinforced with conductive fibres.

### PRIOR ART

The process of electric resistance welding of thermoplastic composites is known and implemented in various configurations. It involves combining frame materials of the welded elements in a liquid state, in a process of mutual diffusion. The process is implemented by slight melting of the top layers of the combined composites, and by simultaneously exerting pressure thereon by means of a force applied in a normal direction. Melting of the frame material proceeds by means of a heating element placed between the combined elements. Usually it is a steel mesh with specified resistance, with a current with a value selected to reach a desired temperature (the melting point of the frame material) flowing therethrough. Temperature control proceeds by means of thermocouples placed in the welding area. The amount of heat emitted during the flow of current through the mesh is determined by the Joule-Lenz law, and it is directly proportional to the product of the electrical resistance of the conductor mesh, the squared current and the time of its flow.

However, the process of electric resistance welding of thermoplastic composites reinforced with carbon fibre suffers from certain defects. Due to the fact that carbon fibre conducts electrical current, there is a risk that during the process, the heating element (mesh) may come into contact with the reinforcement fibres. The current will then ‘escape’ through the fibres, a consequence of which is usually local burning of the welded elements and a sudden drop in temperature in the welding area, resulting in interruption of the process. In order to eliminate such a risk, additional insulating layers are used, usually in the form of a glass fabric laid manually on both sides of the metal mesh. Unfortunately, such protection is technologically poorly reproducible, and, due to additional insulation, it lowers the degree of supersaturation of the mesh with the composite frame, and it is a cause of uneven diffusion of the material between two elements. In order to improve the quality of weld, layers of film of an additional material, i.e. identical to the frame material, are introduced symmetrically on both sides of the mesh.

A welding process modified in this manner improves the quality of the joint and provides an acceptable connection; on the other hand, it turns out that it raises numerous problems during the preparation of the process. This is associated with the necessity to make an additional ‘inset’, meaning to form a pile of numerous individual layers of materials (films, fabrics, mesh), which must be properly placed and precisely fitted to the welded elements. Such a situation rules out the universality and common use of such methodology in a production environment, mainly due to its high labour intensity, and the high risk of the occurrence of errors.

### Advantages of the Invention

The implant according to the invention and the welding method according to the invention improve the reproducibility of the welding process, and reduce the probability of generating defects in the produced weld.

### SUMMARY OF THE INVENTION

The implant for electric resistance welding of elements made of composites has a frame made of thermoplastic materials, in particular reinforced with conductive fibres, in the form of a flat multilayered structure which has an upper and a lower surface, and comprising the following layers: an electrically resistant layer, which has the form of a flat sheet with openings, made of a conductive material, at least two additional layers made of the frame material, one of which covers the electrically resistant layer from the top, and the other one from the bottom. The implant additionally comprises at least two porous insulating layers made of an electrically nonconductive material, one of which covers the implant from the top, contacting the upper layer of the frame material, and the other one covers the implant from the bottom, contacting the lower layer of the frame material. The implant is characterised in that said layers are merged with each other in the form of a flat, multilayered inset for placing between the welded elements, and in that the electrically resistant layer has at least two electrical connections for connecting a source of electrical current.

Preferably, the electrically resistant layer is made of metal, preferably of stainless steel.

Preferably, the electrically resistant layer is made in the form of a mesh or a fabric.

Preferably, the electrically resistant layer has at least two exposed areas, not covered with other layers, for connecting the terminals of the source of electrical current.

Preferably, the layers are merged with each other by pressing in the processing temperature of the frame material in a range from 50° C. to 300° C.

Preferably, the layers of the frame material are made of the following materials: Polyetheretherketone (PEEK) or Polyaryletherketone (PAEK) or Polyphenylene sulphide (PPS).

The invention also comprises a method of electric resistance welding of elements made of composites, with a frame made of thermoplastic materials, in particular reinforced with conductive fibres, by means of a heating element placed between the welded elements, comprising the steps of:
Placing the heating element between the welded elements; Connecting an electrical current power supply to the heating element; Pressing the welded elements with the heating element between them; Activating the electrical current power supply of the heating element; Deactivating the electrical current power supply of the heating element upon reaching the processing temperature of the frame material of the welded elements;
Cutting the parts of the heating element protruding beyond the outline of the welded elements;
characterised in that the heating element is the implant according to the invention, which is configured for electric resistance welding of elements made of composites, with a frame made of thermoplastic materials, in particular reinforced with conductive fibres, in the form of a flat multilayered structure which has an upper and a lower surface, and comprising the following layers: an electrically resistant layer, which has the form of a flat sheet with openings, made of a conductive material, at least two additional layers made of the frame material, one of which covers the electrically resistant layer from the top, and the other one from the bottom. The implant additionally comprises at least two porous insulating layers made of an electrically nonconductive material, one of which covers the implant from the top, contacting the upper layer of the frame material, and the other one covers the implant from the bottom, contacting the lower layer of the frame material. The implant is characterised in that said layers are merged with each other in the form of a flat, multilayered inset for placing between the welded elements, and in that the electrically resistant layer has at least two electrical connections for connecting a source of electrical current.

Preferably, the processing temperature of the frame material of the welded elements ranges from 50° C. to 300° C.

Preferably

### DESCRIPTION OF THE DRAWINGS

FIG. 1 Presents a schematic transverse view of the implant 1.

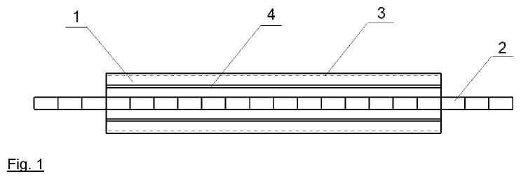

FIG. 1 Presents schematically the method of welding elements using the implant 1.

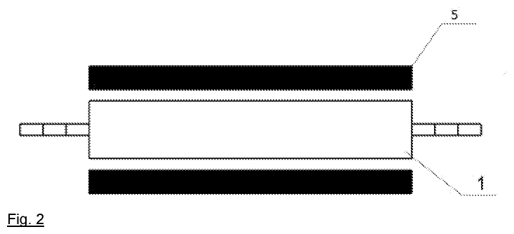

### EMBODIMENT

An embodiment is an Implant (1) which has two insulating layers (3) and two layers of the frame material (4), as well as a metal mesh placed inside as the electrically resistant layer (2). In this case, the insulating layer (3) constitutes a glass fabric, 0.1 [mm] in thickness, and with an area density of 48 [g/m²], while the layer of the frame material (4) is a plastic film made of Polyetheretherketone (PEEK), 0.125 [mm] in thickness. Centrally between the layers, as the electrically resistant layer (2), there is a stainless steel mesh, 0.04 [mm] in thickness. The layers prepared this way are merged by consolidation by means of pressing in a temperature of 322\hat{ }346 [° C.] and under a pressure of 10-15 [bar], resulting in supersaturation of the insulating layers (3) with the frame material from the layer of the frame material (4), and in merging the individual layers into the form of the implant (1).

Depending on the size requirements for the target weld, the implant (1) is made exactly to a size equal to the length and width of the welded elements (5). In the case of very long joints, above 500 [mm], in order to ensure the reliability of the process, it is recommended to use thicker insulating layers (3), with an area density of approx. 100 [g/m²]. On the other hand, due to the necessity to connect the implant (1) to the terminals of a current source, the electrically resistant layer (2) is left properly longer and without coverage (exposed) on both sides of the implant (1).

1. An implant for electric resistance welding of elements made of composites, with a frame made of thermoplastic materials, in particular reinforced with conductive fibres, in the form of a flat multilayered structure which has an upper and a lower surface, and comprising the following layers:
a) An electrically resistant layer, which has the form of a flat sheet with openings, made of a conductive material;
b) At least two additional layers made of the frame material, one of which covers the electrically resistant layer from the top, and the other one from the bottom;
c) At least two porous insulating layers made of an electrically nonconductive material, one of which covers the implant from the top, contacting the upper layer of the frame material, and the other one covers the implant from the bottom, contacting the lower layer of the frame material;
wherein said layers are merged with each other in the form of a flat, multilayered inset for placing between the welded elements, and in that the electrically resistant layer has at least two electrical connections for connecting a source of electrical current.

2. The implant according to claim 1, wherein the electrically resistant layer is made of metal, preferably of stainless steel.

3. The implant according to claim 1, wherein the electrically resistant layer is made in the form of a mesh or a fabric.

4. The implant according to claim 1, wherein that the electrically resistant layer has at least two exposed areas, not covered with other layers, for connecting the terminals of the source of electrical current.

5. The implant according to claim 1, wherein the layers are merged with each other by pressing in the processing temperature of the frame material in a range from 50° C. to 300° C.

6. The implant according to claim 1, wherein the layers of the frame material are made of the following materials: Polyetheretherketone (PEEK) or Polyaryletherketone (PAEK) or Polyphenylene sulphide (PPS).

7. A method of electric resistance welding of elements made of composites, with a frame made of thermoplastic materials, in particular reinforced with conductive fibres, by means of a heating element placed between the welded elements, comprising the steps of:
a) Placing the heating element between the welded elements;
b) Connecting an electrical current power supply to the heating element;
c) Pressing the welded elements with the heating element between them;
d) Activating the electrical current power supply of the heating element;
e) Deactivating the electrical current power supply of the heating element upon reaching the processing temperature of the frame material of the welded elements;
f) Cutting the parts of the heating element protruding beyond the outline of the welded elements;
wherein the heating element is the implant according to claim 1.

8. The welding method according to claim 7, wherein the processing temperature of the frame material of the welded elements ranges from 50° C. to 300° C.
